(19) United States
(12) Patent Application Publication
(10) Pub. No.: US 2024/0370301 A1
(43) Pub. Date: Nov. 7, 2024

(54) IDENTIFICATION OF SUB-GRAPHS FROM A DIRECTED ACYCLIC GRAPH OF OPERATIONS ON INPUT DATA

(71) Applicant: Arm Limited, Cambridge (GB)

(72) Inventors: Elliot Maurice Simons Rosemarine, London (GB); Rune Holm, Oslo (NO)

(73) Assignee: Arm Limited, Cambridge (GB)

(21) Appl. No.: 18/640,250

(22) Filed: Apr. 19, 2024

(30) Foreign Application Priority Data
May 4, 2023 (GB) 2306572.5

(51) Int. Cl. G06F 9/50

(52) U.S. Cl. CPC G06F 9/5027

(57) ABSTRACT

The present disclosure relates to a system, method and non-transitory computer-readable storage medium for handling data. From a directed acyclic graph, DAG, of operations on input data a sub-graph of operations is identified and issued as task data to be executed by a processing module, wherein each of the operations in the sub-graph maps to a corresponding execution unit of the processing module of the system and wherein each connection between operations maps to a corresponding storage element of the processing module. The sub-graph is identified such that a simulation of an execution of the operations of the candidate sub-graph according to a determined size of the processing unit of said input data shows that the processing module can execute the operations of the sub-graph such that memory constrains of the processing module are met and read-write operations to memory external to the processing module are avoided or reduced.

### TECHNICAL FIELD

The present invention relates to methods, processors, and non-transitory computer-readable storage media for handling data for processing by a plurality of operations, such as neural network processing operations and graphics processing operations.

### BACKGROUND

Certain data processing techniques, such as neural network processing a graphics processing, involve the processing and generation of considerable amounts of data using operations. It is desirable to efficiently handle the data when processing by a plurality of operations.

### SUMMARY

According to a first aspect of the present invention, there is provided a system for handling data, the system comprising a host processor and an offload processor, the offload processor comprising a command processing unit connected to a processing module, the processing module comprising a storage with a plurality of storage elements, and a plurality of execution units, the host processor configured to: from a directed acyclic graph, DAG, of operations on input data, identify a sub-graph of operations, wherein each of the operations in the sub-graph maps to a corresponding execution unit of the processing module and wherein each connection between operations maps to a corresponding storage element of the processing module. The host processor is configured to identify the sub-graph of operations by: determining a size of a processing unit of said input data; determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and selecting a first sub-graph from the plurality of candidate sub-graphs, wherein a buffer size of each storage elements of the processing module meets a corresponding estimated required buffer size according to the simulation of the execution of the operations of the first sub-graph. The host processor is further configured to issue first task data describing a task to be executed in the form of a plurality of operations of the first sub-graph to the command processing unit.

According to a second aspect of the present invention, there is provided a method for handling data by a host processor, the host processor being part of a system further comprising an offload processor, the offload processor comprising a command processing unit connected to a processing module, the processing module comprising a storage with a plurality of storage elements, and a plurality of execution units, the method comprising: from a directed acyclic graph, DAG, of operations on input data, identifying a sub-graph of operations, wherein each of the operations in the sub-graph maps to a corresponding execution unit of the processing module and wherein each connection between operations maps to a corresponding storage element of the processing module. Identifying the sub-graph of operations comprises: determining a size of a processing unit of said input data; determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and selecting a first sub-graph from the plurality of candidate sub-graphs, wherein a buffer size of each storage elements of the processing module meets a corresponding estimated required buffer size according to the simulation of the execution of the operations of the first sub-graph. The method further comprises issuing first task data describing a task to be executed in the form of a plurality of operations of the first sub-graph to the command processing unit.

According to a third aspect of the present invention, there is provided a non-transitory computer-readable storage medium comprising a set of computer-readable instructions stored thereon which, when executed by at least one host processor in a system further comprising an offload processor, the offload processor comprising a command processing unit connected to a processing module, the processing module comprising a storage with a plurality of storage elements, and a plurality of execution units, the instructions are arranged to cause the host processor to: from a directed acyclic graph, DAG, of operations on input data, identifying a sub-graph of operations, wherein each of the operations in the sub-graph maps to a corresponding execution unit of the processing module and wherein each connection between operations maps to a corresponding storage element of the processing module, wherein identifying the sub-graph of operations comprises: determining a size of a processing unit of said input data; determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and selecting a first sub-graph from the plurality of candidate sub-graphs, wherein a buffer size of each storage elements of the processing module meets a corresponding estimated required buffer size according to the simulation of the execution of the operations of the first sub-graph; and issuing first task data describing a task to be executed in the form of a plurality of operations of the first sub-graph to the command processing unit.

### BRIEF DESCRIPTION OF THE DRAWINGS

Further features and advantages of the invention will become apparent from the following description of preferred embodiments of the invention, given by way of example only, which is made with reference to the accompanying drawings.

FIG. 1a illustrates an example directed acyclic graph in which sections are interconnected by a series of pipes according to the present disclosure;

FIG. 1b illustrates schematically an example of a data processing system according to the present disclosure;

FIG. 2 illustrates a schematic diagram of a neural engine according to the present disclosure;

FIG. 3 illustrates schematically an example system for allocating handling data according to the present disclosure;

FIG. 4 illustrates an example chain of operations to be performed with a corresponding coordinate space; and

FIG. 5 shows a method for handling data by a host processor according to the present disclosure.

### DETAILED DESCRIPTION

This disclosure describes procedures, as well as methods, systems and computer-readable media for handling data.

A first aspect of the disclosure relates to a system for handling data. The system may for example be a system on a chip (SoC). The system comprises a host processor. The host processor may for example be a central processing unit (CPU). The system further comprises an offload processor such as a graphics processing unit (GPU), Neural Processing Unit (NPU), an Application-Specific Integrated Circuits (ASIC) or a Field-Programmable Gate Array (FPGA). The offload processor may comprise a command processing unit connected to one or more processing modules. The processing module may for example be a neural engine (NE). The processing module comprises a storage with a plurality of storage elements, and a plurality of execution units. Such a system may advantageously be used to execute operations on input data. The operations may be in the form of a directed acyclic graph, DAG. The host processor may instruct the processing module to execute the operations. The processing module may have different hardware constraints, such as the number and type of execution units, memory constraints of the storage and storage elements and storage bandwidth of the storage and/or storage elements.

To best take advantage of the processing unit according to its constraints to execute the operations of the DAG, it may be advantageous to divide the DAG of operations into a plurality of sub-graphs of operations. A sub-graph in this context refers to a portion of the DAG that can be isolated and treated as its own smaller DAG. Each operation of the sub-graph can then be mapped to a corresponding execution unit of the processing module and each connection between operations can be mapped to a corresponding storage element of the processing module, such that execution of the operations of the sub-graph can be performed efficiently.

From the DAG, a plurality of candidate sub-graph is determined according to set requirements. This process will be further discussed below.

To select a suitable sub-graph from the candidate sub-graphs, a size of a processing unit of the input data is determined. Based on the determined size, a required buffer size of each storage element mapping to the connections between the operations of the candidate sub-graph may be determined by simulating an execution of the operations of the candidate sub-graph according to the determined size of the processing unit of said input data.

A first sub-graph from the plurality of candidate sub-graphs may then be selected, wherein a buffer size of each storage elements of the processing module meets a corresponding estimated required buffer size according to the simulation of the execution of the operations of the first sub-graph. In this way, sub-graphs may be determined that meet the memory constrains of the processing module such that read-write operations to memory external to the processing module are avoided or reduced.

The host process may then be configured to issue first task data describing a task to be executed in the form of a plurality of operations of the first sub-graph to the command processing unit of the offload processor. The task data may be issued as part of a command stream. A command stream may comprise at least one command in a given sequence, each command to be executed, and each command may be decomposed into a number of tasks, such as tasks discussed in this document.

The command processing unit may then use the respective execution units to execute the operations, as will be further described below.

In some examples, an operation space may be determined for the first sub-graph, the operation space representing dimensions of a multi-dimensional arrangement of the operations of the first sub-graph to be executed.

The operation space refers to a common operation space for operations to be executed by the executions units to execute the task according to the first sub-graph. By defining such a common operation space, chaining of the functions needed to perform the task may be simplified and efficient coordination of the task by the processing module may be achieved. By providing the capability to operate upon a sequence of connected operations (also referred herein as sections) that can be defined within an operation space common to the sequence of operations (i.e., the sub-graph), it can be guaranteed that all coordinates required by the operations within the operation space are reachable when executing that sequence of operations. However, it is not necessary for each operation to be of the same type or nature. Consequently, an operation-specific local space may a different number of dimensions as long as the transformation required to go from the operation space to the operation-specific local space is “onto”, i.e. all points in the integer operation-specific local space can be reached from the integer global operation space.

Typically, one of the operation-specific local spaces of the operations in the sub-graph is chosen and declared as the operation space for the first sub-graph.

In some embodiments, the operation space for the first sub-graph is determined by: for each operation of the first sub-graph, determining an operation-specific local space, and determining the operation space by selecting the operation-specific local space having a highest dimensionality. This may be a low complexity way of determining an operation space where all transformations required to go from the operation space to the each of the operation-specific local spaces of the remaining operations in the sub-graph is “onto”.

In some embodiments, the host processor is, when determining a plurality of candidate sub-graphs from the DAG, configured to: select one or more operations forming an initial candidate sub-graph in the DAG, select a first operation in the DAG connected to the initial candidate sub-graph in a forward traversal direction, analyse whether adding the first operation to the initial candidate sub-graph results in a recompute of any data item of the input data to the selected operation at a parent node to the selected operation in the initial candidate sub-graph; upon adding the first operation to the initial candidate sub-graph not resulting in a recompute, form a candidate sub-graph by adding the first operation to the initial candidate sub-graph. In other words, from the initial candidate sub-graph, that may contain one or more of the operations of the DAG, attempt to grow it “downwards” (add successor operations/chains of operations) as long as adding in the successor would not result in recompute. In this embodiment, an advantageous balance between memory traffic and compute may be achieved.

In some examples, host processor is, when determining, from the DAG, a plurality of candidate sub-graphs, configured to: select one or more operations forming an initial candidate sub-graph in the DAG, select a second operation in the DAG connected to the initial candidate sub-graph in a backwards traversal direction, upon determining that less than a threshold number of the execution units of the one or more operations of the initial candidate sub-graph equals the execution unit of the second operation, form a candidate sub-graph by adding the second operation to the initial sub-graph. In other words, from the initial candidate sub-graph, that may contain one or more of the operations of the DAG, attempt to grow it “upwards” (add predecessor operations/chains of operations), until the number of operations in the candidate sub-graph that requires a same execution unit exceeds a threshold. The threshold may differ between execution units, for example an execution unit of type A may be allowed 2 times in sub-graph while an execution unit of type B may be allowed only once. Defining thresholds for different types of executions units facilitate an efficient execution of the operations of the sub-graph by the processing module depending on hardware restrictions of that particular processing module.

In some examples, the host processor is, when selecting one or more operations forming an initial candidate sub-graph in the DAG, configured to determine storage bandwidth requirements of the operations of the DAG. Depending on the hardware implementation of the processing module, limitations on which storage elements (also referred to as pipes herein) that can connect to each other e.g., due to SRAM bandwidths constraints. For example, a convolution engine (CE) may require a buffer that needs to have very high bandwidth which may result in that an output writer may not directly access the same buffer. In this example, the CE output may need to be accessed by a vector engine (VE) that receives the output from the buffer which the CE is writing to.

In some examples, the system comprises a second offload processor comprising a second command processing unit connected to a second processing module, the second processing module comprising a storage with a plurality of storage elements, and a plurality of execution units. In this case, the host processor is configured to identify a second sub-graph of operations, wherein each of the operations in the second sub-graph maps to a corresponding execution unit of the second processing module and wherein each connection between operations maps to a corresponding storage element of the second processing module, wherein the host processor is configured to identify the second sub-graph of operations by: selecting a second sub-graph from the plurality of candidate sub-graphs, wherein a buffer size of each storage elements of the second processing module meets a corresponding estimated required buffer size according to the simulation of the execution of the operations of the second sub-graph, and issuing second task data describing a second task to be executed in the form of a plurality of operations of the second sub-graph to the second processing module. Advantageously, the SoC may comprise a second offload processor (e.g., GPU) which the CPU uses to execute parts of the DAG. Advantageously, a DAG may be executed more efficiently, without requiring much communication and synchronization between the first and the second offload processor.

In other examples, an offload processor comprises a plurality of processing modules (e.g., >1 NEs). In this case, the command processing unit may coordinate such that the tasks of the received sub-graph is further divided into sub-tasks that can be executed by the plurality of processing modules or that one task (i.e., a first sub-graph) may be executed by a first processing module and a second task (i.e., a second sub-graph) may be executed by a second processing module.

In some examples, the host processor is configured to iteratively performing the steps of selecting sub-graphs from the candidate sub-graphs until all selected sub-graphs connected together forms the DAG. In this way, it may be ensured that the entire DAG of operations is executed.

In some embodiments, at least two connections between operations in the first sub-graph maps to a same corresponding storage element of the first processing module. Consequently, for operations that may share storage elements, dividing the DAG into sub-graphs may ensure that the internal memory buffers of the processing modules is utilized in an efficient way while the chain of operations flow through the hardware.

In some embodiments, the host processor is configured to compile the first task data into machine instructions. This may provide an efficient, secure, and compatible way of communicating instruction between two hardware units.

In some examples, the host processor is, when estimating a required buffer size, configured to simulate a worst case for each non-linear operations of the operations of the candidate sub-graph. The processing unit (according to its determined size)) may for example be projected through the operations of the candidate sub-graph using a special worst-case mode that calculates the worst case for all non-linear operations (e.g., clipping is simply disabled). The resulting bounding box gives us the worst case storage requirements for the storage elements involved when executing the operations.

A second aspect of the disclosure relates to a method for handling data by a host processor, the host processor being part of a system further comprising an offload processor, the offload processor comprising a command processing unit connected to a processing module, the processing module comprising a storage with a plurality of storage elements, and a plurality of execution units, the method comprising: from a directed acyclic graph, DAG, of operations on input data, identifying a sub-graph of operations, wherein each of the operations in the sub-graph maps to a corresponding execution unit of the processing module and wherein each connection between operations maps to a corresponding storage element of the processing module, wherein identifying the sub-graph of operations comprises: determining a size of a processing unit of said input data; determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and selecting a first sub-graph from the plurality of candidate sub-graphs, wherein a buffer size of each storage elements of the processing module meets a corresponding estimated required buffer size according to the simulation of the execution of the operations of the first sub-graph. The method further comprises issuing first task data describing a task to be executed in the form of a plurality of operations of the first sub-graph to the command processing unit.

The second aspect may generally have the same features and advantages as the first aspect.

A third aspect of the disclosure relates to a on-transitory computer-readable storage medium comprising a set of computer-readable instructions stored thereon which, when executed by at least one host processor in a system further comprising an offload processor, the offload processor comprising a command processing unit connected to a processing module, the processing module comprising a storage with a plurality of storage elements, and a plurality of execution units, the instructions are arranged to cause the host processor to: from a directed acyclic graph, DAG, of operations on input data, identifying a sub-graph of operations, wherein each of the operations in the sub-graph maps to a corresponding execution unit of the processing module and wherein each connection between operations maps to a corresponding storage element of the processing module, wherein identifying the sub-graph of operations comprises: determining a size of a processing unit of said input data; determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and selecting a first sub-graph from the plurality of candidate sub-graphs, wherein a buffer size of each storage elements of the processing module meets a corresponding estimated required buffer size according to the simulation of the execution of the operations of the first sub-graph. The computer-readable instructions are further arranged to cause the host processor to issuing first task data describing a task to be executed in the form of a plurality of operations of the first sub-graph to the command processing unit.

The third aspect may generally have the same features and advantages as the first aspect.

### Execution of a Directed Acyclic Graph (DAG)

The present disclosure relates to execution of a task in the form of a plurality of operations on data. Many data structures to be executed in a processor can be expressed as a directed acyclic graph. Examples of such data structures include neural networks which can be represented as a directed acyclic graph of operations that wholly compose the operations required to execute a network (i.e. to executed the operations performed across the layers of a neural network). A directed acyclic graph is a data structure of operations (herein also referred to as ‘sections’) having directed connections therebetween that indicate a flow of operations such that those directed connections do not form a closed loop. The connections between operations (or sections) present in the graph of operations are also to referred herein as ‘pipes’. An acyclic graph may contain any number of divergent and convergent branches.

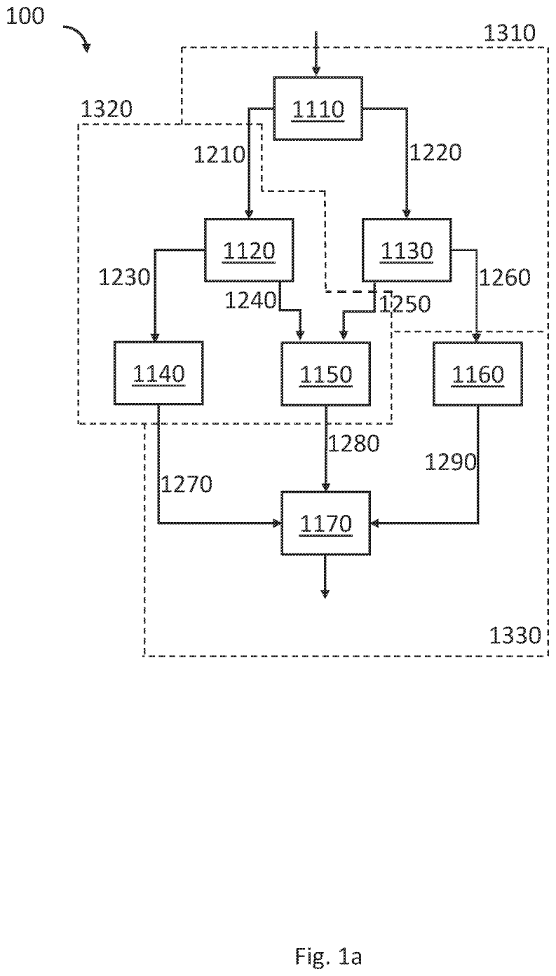

FIG. 1a illustrates an example directed acyclic graph in which sections are interconnected by a series of pipes. Specifically, an initial section, section 1 (1110) represents a point in the acyclic graph at which an operation, operation A, is to be performed when executing the graph. The output of operation A at section 1, 1100, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the acyclic graph may receive multiple inputs, each from a respective different section in the acyclic graph via a respective different pipe. For example, section 1150 in FIG. 1a receives a first set of input data via pipe 1240 from section 1120 and a second set of input data via pipe 1250. Depending on the nature of the operation performed in a particular section and the dependencies of subsequent operations on the output of the operation, any number of input and output pipes may be connected to a particular section in the acyclic graph.

The acyclic graph can be represented by a number of sub-graphs each containing a subset of the sections in the graph. FIG. 1a illustrates an arrangement where the graph 100 is broken down into three sub-graphs 1310, 1320, and 1330 which can be connected together to form the complete graph. For example, sub-graph 1310 contains sections 1110 and 1130 (as well as the corresponding pipe 1120), sub-graph 1320 contains sections 1120, 1140, and 1150 (as well as corresponding pipes 1230, 1240), and sub-graph 1330 contains sections 1160 and 1170.

The deconstruction of a graph 100 into sub-graphs is particularly useful when seeking to execute the graph since it would be possible to separately execute the sub-graphs which allows for parallelization of execution where there are no dependencies between sub-graphs. This can be particularly useful in a multi-processor environment where sub-graphs can be allocated for execution by different processors in the multi-processor environment. However, as shown in FIG. 1a sub-graph 1320 has a dependency on the execution of operation A and section 1110 and sub-graph 1330 has a dependency on sub-graph 1310. As such, execution of sub-graph 1330 may need to be stalled until sub-graph 1310 has been completed. Moreover, hardware constraints of the processing module executing the sub-graph as well as other constraints will apply. It will therefore be appreciated that it is necessary to carefully select the appropriate sub-graph arrangement to maximize or improve the execution efficiency of the graph. This will be further discussed below.

### Hardware Implementation

As described above, a data structure in the form of a directed acyclic graph may comprise plural sequenced operations that are connected to one another for execution in a chain. Described below is an example hardware arrangement for executing chained operations for at least a portion of a directed acyclic graph as illustrated in FIG. 1a.

FIG. 1b shows schematically an example of a data processing system 600 including offload processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g., supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable, to utilize some of the GPU's existing resources (e.g., such that at least some functional units and resource of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g., an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor, this means that the machine learning processing circuit is preferably then operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 1b, the processor 630 is arranged to receive a command stream 620 from a host processor 610, such as a central processing unit (CPU). The command stream comprises at least one command in a given sequence, each command to be executed, and each command may be decomposed into a number of tasks, such as tasks discussed in this document. These tasks may be self-contained operations, such as a given machine learning operation or a graphics processing operation. It will be appreciated that there may be other types of tasks depending on the command.

The command stream 620 is sent by the host processor 610 and is received by a command processing unit 640 which is arranged to schedule the commands within the command stream 620 in accordance with their sequence. The command processing unit 640 is arranged to schedule the commands and decompose each command in the command stream 620 into at least one task. Once the command processing unit 640 has scheduled the commands in the command stream 620, and generated a plurality of tasks for the commands, the command processing unit issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader takes, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second may both be neural processing tasks issued to a first processing module 652a, 652b, which is a neural engine. Such a neural processing task may involve the processing of a tensor, e.g., representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data use for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the command stream 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBA®) interface, such as the Advanced extensible Interface (AXI), may be used.

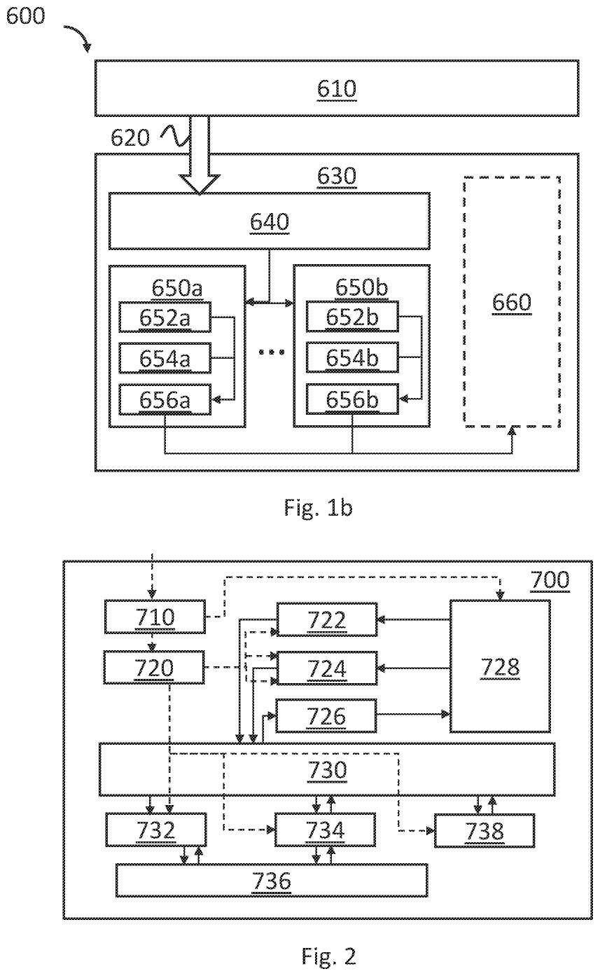

FIG. 2 is a schematic diagram of a neural engine 700, which in this example is used as a first processing module 652a, 652b in a data processing system 600 in accordance with FIG. 1b. The neural engine 700 includes a command and control module 710. The command and control module 710 receives tasks from the command processing unit 640 (shown in FIG. 1b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the acyclic graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a chain of operations representing a sequence of layers of the neural network. A block of data is allocated as an input to one of the operations by the handling unit 720.

The handling unit 720 coordinates the interaction of internal components (also referred to as execution units herein) of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a storage 738, for processing of blocks of data. The data dependencies across the functional units are tracked by the handling unit 720. Processing is initiated by the handling unit 720 in a functional unit if all input blocks are available and space is available in the storage 738 of the neural engine 700. The storage 738 may be considered to be a shared buffer, in that various functional units of the neural engine 700 share access to the storage 738.

In the context of a directed acyclic graph representing the operations to be performed, each of the internal components that operates upon data can be considered to be one of two types of component. The first type of component is an execution unit (and is identified within the neural engine 700 as such) that maps to a section that performs a specific instance of an operation within the acyclic graph. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The connections between sections in the acyclic graph representing the neural network are also referred to as pipes within the context of the acyclic graph. These pipes can also be mapped to the uniquely identified physical storage elements of a storage in the neural engine. For example, the accumulator buffer 736 and storage 738 (and portions thereof) can each be regarded as a storage element that can act to store data for a pipe within the acyclic graph. The pipes act as connections between the sections (as executed by execution units) to enable a sequence of operations as defined in the acyclic graph to be chained together within the neural engine 700. Put another way, the logical dataflow of the acyclic graph can be mapped to the physical arrangement of execution units and storage elements within the neural engine 700. Under the control of the handling unit 720, execution can be scheduled on the execution units and data can be passed between the execution units via the storage elements in accordance with the mapping, such that the chained operations of a graph can be executed without needing to write data memory external to the neural engine 700 between executions. The handling unit 720 is configured to control and dispatch work representing performing an operation of the graph on at least a portion of the data provided by a pipe.

The weight fetch unit 722 fetches weights associated with the neural network from external storage and stores the weights in the storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 730, vector engine 732 and transform unit 734 to generate output data corresponding to an operation in the acyclic graph. The result of each operation is stored in a specific pipe within the neural engine 700. The DPU array 730 is arranged to perform one or more operations associated with a dot product operation between two operands, such as between an array of weights and a corresponding block of data (e.g., representing part of a tensor). The vector engine 732 is arranged to perform elementwise operations, for example to apply scale parameters to scale an output of a dot product calculated by the DPU array 730. Data generated during the course of the processing performed by the DPU array 730 and the vector engine 732 may be transmitted for temporary stage in the accumulator buffer 736 which acts as a pipe between the previous operation and the subsequent operation, from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data from a pipe, such as storage 738 (e.g., after processing by the DPU array 730 and/or vector engine 732), and writes transformed data back to the storage 738.

To make efficient use of the storage 738 available within the neural engine 700, the handling unit 720 determines an available portion of the storage 738, which is available during execution of part of a first task (e.g., during processing of a block of data associated with the first task by the DPU array 730, vector engine 732 and/or transform unit 734). The handling unit 720 determines a mapping between at least one logical address associated with data generated during execution of a second task (e.g., by processing of a block of data associated with the second task by the DPU array 730, vector engine 732 and/or transform unit 734) and at least one physical address of the storage 738 corresponding to the available portion. The logical address is for example a global address in a global coordinate system. Hence, by altering the physical address corresponding to a given logical address, the handling unit 720 can effectively control usage of the storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements. In particular, a single execution unit may be configured at different instances in time to execute different instances of a convolution operation (e.g., first and second sections). Similarly, the input reader may be required to read data as part of different sections in the graph. The same can be said for storage elements and pipes.

All storage in the neural engine 700 may be mapped to corresponding pipes, including look-up tables, accumulators, etc. Some storage may be relatively fixed purpose, for example, if the hardware were limited to one convolution operation per graph the accumulator buffer might also be limited to being mapped to one pipe, and scale/bias/shift buffer might be limited to being mapped to one pipe; however, both would likely be double buffered. If the neural engine supports 2 look-up tables (LUTs), then a maximum of 2 pipes could be used to target the LUTs to avoid needing to thrash the LUT storage; LUT pipes might then be single buffered. All other pipes could be mapped to a common Shared Buffer (or portions thereof) with fewer restrictions. Width and height of pipe can also be programmable, resulting a highly configurable mapping between pipes and storage elements within the neural engine 700.

Ordering of execution of the sections is implied by dependencies on inputs. A memory load operation has no data dependencies (unless it is a gather operation), so is implicitly early in the graph. The consumer of the pipe the memory read produces is implicitly after the memory read. A memory store operation is near the end of the graph, as it produces no pipes for other operations to consume. The sequence of execution of a chain of operations is therefore handled by the handling unit 720 as will be explained in more detail later.

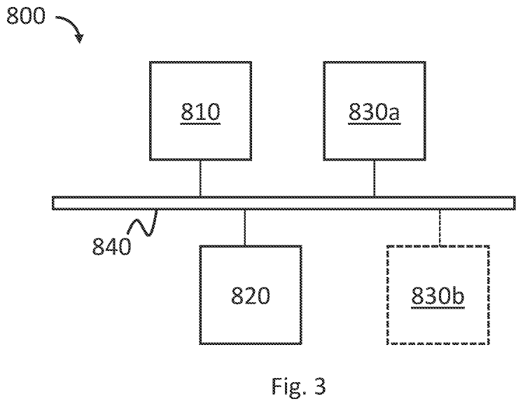

FIG. 3 shows schematically a system 800 for allocating handling data, and in some examples generating a plurality of blocks of input data for processing.

The system 800 comprises host processor 810 such as a central processing unit, or any other type of general processing unit. The host processor 810 issues a command stream comprising a plurality of commands, each having a plurality of tasks associated therewith.

The system 800 also comprises an offload processor 830a, which may be similar to or the same as the processor 630 of FIG. 1b and may comprise at least some of the components of and/or be configured to perform the methods described above. The processor 830a comprises at least a plurality of compute units 650a, 650b and a command processing unit 640. Each compute unit may comprise a plurality of processing modules each configured to perform at least one type of operation. The system 800 may also include at least one further processor 830b, which may be the same as the processor 830a. The processor 830a, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBAR) interface, such as the Advanced extensible Interface (AXI), may be used.

### Operation Space and Operation-Specific Local Space

When executing chains of operations, for example structured in a directed acyclic graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed. The inventors have recognized that the possible set of operations from which sections can be formed can be hard to manage when seeking to design hardware to enable the execution (also referred to as “acceleration”) of these operations-particularly when chained together. For example, enabling fixed-function operation of each possible type of operation can result in inefficient hardware by requiring support for obscure or complex operations (sections).

In order to provide for a flexible traversal pattern when performing a task comprising operations on data, where the operations to be performed and the dimensions of the data may differ between different task, it may be advantageous to define a multi-dimensional operation space. Most operations on data in this context may be expressed as a nested for-loop with operations. For example, a 2D convolution operation on an input tensor may be expressed as a 7D loop of scalar operations. Consequently, defining a general operation space in a coordinate system having for example eight dimensions may provide a low complexity pattern for execution of any task comprising operations on data, instead of relying on fixed functions per task type, which may encompass a significant risk of missing necessary combinations of patterns. By defining a common operation space for a task in the form of a plurality of operations on data, it may be less complex to chain a plurality of operations to be executed on data to each other and coordinate execution of these operations.

For example, consider a 2D convolution operation which can be expressed as a multi-dimensional loop of scalar operations. These may need to be executed on input 2D input data having dimensions input X (IX) and input Y (IY):
(input) Input channel (IC)—a dimension representing the input channels upon which the operation is to be performed (in the example of images this may be three channels each representing one of red, green, and blue input channels)
(input) Kernel dimension X (KX)—a first dimension X of a 2D kernel;
(input) Kernel dimension Y (KY)—a second dimension Y of a 2D kernel;
(output) Output X (OX)—a first dimension of the output feature map for the convolution operation;
(output) Output Y (OY)—a second dimension of the output feature map for the convolution operation;
(output) Batch (N)—a batch dimension of the operation, where the operation is to be batched;
(output) Output channel—a dimension representing the output channels to be produced for the 2D convolution operation.

In one proposed ordering, KY/KX can be consider the inner-most dimensions and N is the outer-most dimension.

For the 2D convolution operation example above, it is possible to express the operation to be performed as a “nested for-loop” of scalar operations as is illustrated in the pseudocode set out below. In practice, when executing this operation, it is necessary for a processor to execute the operation across each of these dimensions by performing a multiple-accumulate operation (MAC), the result of which is then written into an accumulator (e.g. an accumulator buffer in hardware). Having operated through all of these dimensions, the 2D convolution is completed and the contents of the accumulator therefore represents the result of the 2D convolution operation across the entire dimensionality of operation.

```
for(output channel)
  for(batch N)
    for(output Y)
      for(output X)
        for(input channel)
          for(kernel Y)
            for(kernel X)
              MAC
              write accumulator
```

In some examples, the operation space contains 8 dimensions (N=8). Eight dimensions in operation space may allow execution of all neural operations. In other examples, the number of dimensions is less or more. The processes and techniques described herein are not limited to any number of dimensions in operation space. The number of dimensions may differ based on the requirements of the processor and what tasks it is specified to execute.

Operation space dimensions does not have a specific interpretation until they are projected into space for a specific task. This space is referred to as operation-specific local space, or section space, herein. As described above, different operations having different types may be chained together by defining the common operation-space for the whole graph (or chain of operations), and then defining transforms from the operation-space to each operation's individual section-space. Operation-space is typically mapped to a specific operation's local space in the graph, with programmatic transforms provided for all other operations. As described herein, the transformation from operation space to section space (and therefore the management of compatibility and correct structuring of data between consecutive operations) is managed and issued centrally by a single handling unit based upon the dimensionality of a pre-defined operation space—e.g., by a descriptor that defines the operation space and the sections and pipes that form the graph.

In some examples, an operation's section space might be mapped to input and/or output. When considering the acyclic graph data structure described above in respect of FIG. 1a, the operation performed in each section of the graph can be defined by the set of input and output transform matrices for that operation. The input and output matrices can then be applied to a block in operation space to determine a range of values for the input and output of that operation. These determined ranges of values represent the operation-specific local space for that operation, which forms a local coordinate system on which that operation can be executed for that block of the operation space.

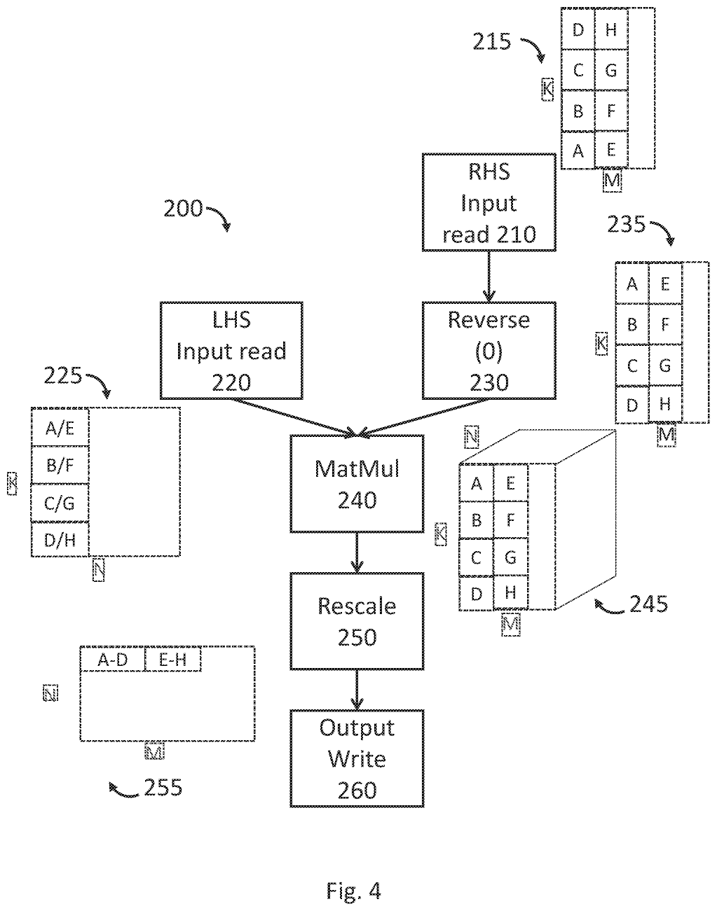

FIG. 4 illustrates an example chain 200 of operations to be performed. The chain comprises a left-hand-side (LHS) input read operation 220 and a right-hand-side (RHS) input read operation 210. The output of the RHS input read operation 210 is input into a Reverse operation 230 which in turn is output, along with the output of the LHS Input Read operation 220 into a Matrix Multiplication (MatMul) operation 240. The output of the MatMul 240 operation is input into a Rescale operation 250, the output if which is provided to an Output Write operation 260 that writes the output to memory.

FIG. 4 also illustrates the corresponding coordinate space (i.e., the section space, or operation-specific local space, for each of the operations). For example, the RHS Input Read section space 215 is illustrated for the RHS Input Read 210 operation. The LHS Input Read section space 225 is illustrated for the LHS Input Read operation 220. The Reverse section space 235 is illustrated for the Reverse operation 230. The MatMul section space 245 is illustrated for the MatMul operation 240. The Rescale section space 255 is illustrated for the Rescale operation 250. In this example, the section space for the Output Write operation is illustrated using the section space 255 since this is unchanged from the section space for the Rescale operation.

Each section space comprises a plurality of dimensions—namely two dimensions (e.g. K,N; K,M). The section space is separated into blocks having a pre-defined block size—with each of blocks A to H representing a different block to be operated on in line with the examples set out herein.

As can be seen, the Reverse section space 230 has a dimensionality which is effectively reversed with respect to the RHS Input Read section space 215. Section space 225 for the LHS Input Read contains blocks A/E, B/F, C/G, D/H which are repeated. The section space 255 for the Rescale and Output Write operation contains two blocks, A-D and E-H. This is because the MatMul operation is a reduction operation. In the MatMul example in FIG. 4, a MatMul of two matrices 225 with 235 is performed. Matrix 225 has dimensions K×N and matrix 235 has dimensions K×M. The output 255 has dimensions N×M, so the K dimension has been reduced. MatMul could be described with the 3D operation space of N, M, K.

As will be appreciated the operations set out in FIG. 4 are sections which can be respectively executed by different execution units. The handling unit may be configured to control execution of the various blocks such that a particular block is able to flow through the chain of operations defined by the graph or sub-graph. The “A/E” notation in FIG. 7 illustrates that a block is being repeated. For example, blocks A and E have the same coordinates in some dimensions (K, N) but there is another dimension (M) that has changed but is not mapped into 220's coordinate space. The “A-D” notation indicates that blocks have been reduced and merged into a single block. E.g. blocks A, B, C, D have been reduced down into a single block. These blocks vary in dimension K, but dimension K has been reduced.

When determining an operation space for a chain of operations, such as the example chain 200 in FIG. 7, two conditions may be considered:
1) The transform from chain operation space to section space must be “onto” for all sections. That is, each point in section space must be reachable from the chain operation space. If this is not satisfied, the entire section may not be calculated, which is usually an error.
2) After transform from chain operation space to section space, all “output” dimensions must be ordered to the left of “reduction” dimensions, assuming a right-to-left iteration order. See for example the example of the nested for-loop above where outer dimensions correspond to left and inner dimension to right. This ensures that we complete reductions before passing reduced data onto the next section in the chain. This in turn facilitate that the intermediate storage is not dependent on the size of the output. This is a good property, because arbitrarily sized matrices may be supported with a fixed amount of intermediate storage.

To achieve 1) and 2) above, the following strategies may be used.
a) pick the section with the most complex section space declare that to be the chain operation space.
b) use strategy a) but allow transposes of dimensions between chain operation space and primary section space. This makes it easier to satisfy condition 2).
c) Start with an empty chain operation space, go down the sections, and add dimensions to chain operation space as necessary to make transforms “onto”.

Strategy a) and b) are low complexity strategies which may be preferred over strategy c). In the example of FIG. 4, this would mean that the MatMul section space 245 is selected as the operation space.

An operation-space and a set of operation-specific local spaces have thus been determined. Here follow some examples of chains and their transforms to get from the operation-space and to the operation-specific local spaces:
Input (IFM, input channel)->Transpose->Output (OFM, output channel). Operation-space may match Transpose local-space, which is defined by its output. Therefore, identity transform needed for Output. For Input, a transform that describes the inverse of the Transpose operation is needed.
Inputs (IFM and Weights as two separate inputs)->Conv2D->Output. Operation-space may match Conv2D local-space (OC, N, OY, OX, IC, KY, KX), which is defined by its output (OC, N, OY, OX). Therefore, an identity transform is needed for Output, with some dimensions unmapped. For Input, a transform that describes the inverse of the Conv2D operation, and also marks some dimensions unmapped, is needed.
Inputs->Transpose one of the inputs->Conv2D->Output. Operation-space may match Conv2D. Transpose operation thus requires inverse Conv2D, while its input needs a further inverse of the Transpose operation. In other words, the Input needs a concatenated transform: inverse Conv2D and inverse Transpose.

Moreover, some operations, and thus their operation-specific local spaces, are defined by their outputs and some are defined by their inputs, which affect the transforms required to get from the operation-space to the respective operation-specific local spaces. Consequently, complex chains may need complex arrangements of transforms from operation-space to operation-specific local spaces. Concatenation of the transforms may thus provide an advantage, wherein multiple levels of forward and/or inverse transforms may be concatenated.

### Programmability of Operation Space to Section Space Transforms

As discussed above, the operation space for a task (sub-graph) may contain a pre-determined number of dimensions (e.g. eight) but the local section space for the operation to be performed for a specific section in that graph can contain fewer than 8 dimensions. Also, as described herein, the handling unit may iterate through the operation space in units known as blocks, transforming each block from the common operation-space to a section-specific space described by the various fields in neural engine program descriptor (NED), which is a data structure stored in memory and retrieved by the neural engine when executing the task issues by the command processing unit. The NED further describes at least a portion of a complete graph of operations (sections) to be performed when executing the graph of operations (e.g. representing a neural network). As discussed above, sections are mapped to various hardware execution units within the neural engine and essentially represent instantiations of a particular operator at a position within the graph. In one example, these sections are described by specific ‘elements’ that collectively define the operations forming part of the NED.

In an example implementation, the NED may further comprise for each element in the NED (e.g. each section/pipe) a program comprising transform program data that describes a transform from operation space to section space (local space) for the corresponding section. In one such implementation, each element in the NED may comprise an offset value that points to the specific program within the NED for executing the transform. This offset value may be regarded as a pointer into ‘program space’, being the space in which all the programs which define the various enabled transforms are located. Alternatively, the offset value may be a pointer into a virtual address space in main memory. For example, this program space can be defined in the NED as a field tsu_space_size which for example is sized as 256 bytes. The offset may point to a memory location at which the start of its section-space transform is placed (e.g. the first instruction in a sequence of instructions which collectively define a program for performing the transform).

Each transform program may end with an explicit END instruction, and may be followed without any spacing or alignment by a next program defining a sequence of instructions for executing a different transform that is associated with a different element. Alternatively a starting pointer may be used in conjunction with a total number of instructions to execute.

In an example implementation, the sequence of instructions used for each transform may be selected from a set of pre-determined instructions which effectively form an instruction set. This instruction may be regarded as a transform instruction set which may be a specific set of instructions selected optimally to perform transforms from operation space to section space. Alternatively, the transforms may be general purpose instruction set as seen in a central processing unit (CPU).

In an example implementation, a transform instruction may operate on a set of state values for the transform. The state values comprise boundary registers (in one example eight boundary registers b [0] to b [7]) each comprising a low and a high component. Each block in the operation space is defined by the values described in the low and high components of the eight boundary registers. These values indicate the upper and lower bounds (inclusive) for the coordinates in the block for that axis of the “bounding box” operation space.

In this example, no other state is available to the instructions which operate to transform the operation space to a local section space for a specific operation to be performed. All operations performed by the instructions therefore operate on the boundary registers, including intermediate calculations.

Some sequences of instructions will transform one dimension at a time, starting with dimension 0 (e.g. b [0]) and work iteratively inwards through the dimensions. In other more complex sequence of instructions, more complex transforms may need to jump around by modifying the destination register identifier explicitly e.g. by using a SETD instruction in the set of instructions.

An example of a transform program to be used to transform the output dimensions of a convolution operation are set out below using a register swap instruction with destination modifier D and dimension d:

program, 4 instructions, 4 bytes
(d=0) Register swap b[d], b[1] //swap OC and N
(d=1) SWP.D b[d], b[2] //swap OC and OY
(d=2) SWP.D b[d], b[3] //swap OC and OX
END

This sequence of instructions represents the following affine transformation for the output dimensions of the convolution operation:

| OFM | OC | N | OY | OX | IC | KY | KX | Offset |
|---|---|---|---|---|---|---|---|---|
| N | | 1 | | | | | | |
| OY | | | 1 | | | | | |
| OX | | | | 1 | | | | |
| OC | 1 | | | | | | | |
| | | | | | | | | 1 |

The result of executing the transform program for a specific block defines a block in section space, ready to be used for the invocation of the specific hardware execution unit that is to execute the section. In the case of many types of operation to be performed by a hardware execution unit to execute a section, the execution unit does not use a full 8-dimension section space. The handling unit therefore defines an invocation structure for each unit that defines the relevant requirements for that operation.

For example, having complex sub-graph of operations (e.g. Tranpose->Conv2D->Transpose), with multiple transforming operations may require complicated transforms to get from operation space to local space as described above. Implementing a fixed function datapath to determine the needed transforms would need to define a forward and inverse transform for every possible operation. Combinations for chains are largely unconstrained meaning lots of possible combinations of concatenated chains. Further, consider that some operation transforms are varied based on parameters: Conv2D transform is affected by kernel size as well as padding, stride, dilation, etc.

Instead of a fixed-function datapath, a generic instruction-set datapath for transforms may be implemented. The bounding box of a block is mapped to registers as described above: e.g., 8 boundary registers (8D op-space), with each boundary register having an upper/lower value. Some instructions modify both upper and lower, some only one or the other. Instructions take source/destination registers, wherein each register represents one of the dimensions. Using this strategy, a wide variety of forward and inverse transforms may be implemented. Furthermore, verification is simplified: for example, by isolating basic operations such as an add instruction. Moreover, concatenated transforms may not need to be described as a series of transforms applied one after the other. Instead, multiple transforms may be flattened down into a single program.

In some embodiments, the TSU (handling unit, ref 720 in FIG. 2) is s responsible for sequencing blocks in the operation-space through the sections and invoking the sections. Before invoking, the operation-space block needs to be transformed to local-specific operation space. With the generic instruction-set datapath for transforms as described above, more complex chains may be handled.

### Identification of Sub-Graphs from a DAG

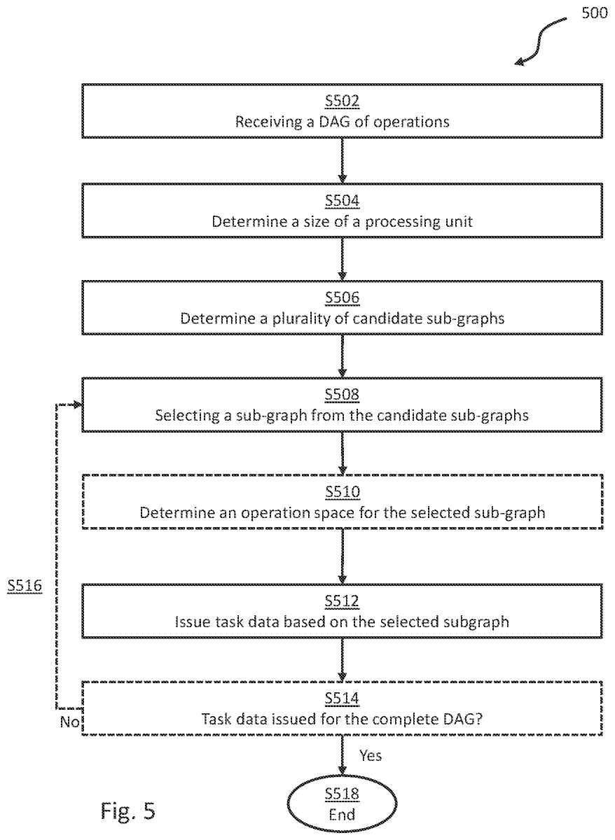

Embodiments of how to identify suitable sub-graphs from a DAG of operation (as exemplified in FIG. 1a) will now be described in conjunction with FIG. 5. FIG. 5 shows an example of a method 500 executed by a host processor. The host processor is part of a system (e.g., SoC) as exemplified in FIG. 3 and connected to an offload processor as exemplified in FIG. 1b. The offload processor comprises a command processing unit connected to a processing module as exemplified in FIG. 2.

The method 500 is a method for identifying a sub-graph from a directed acyclic graph, DAG, of operations on input data.

The method 500 comprises the host processor receiving s502 a DAG of operations. The DAF may be received from an application launched by a user. The application may for example run neural network being part of the application. From the DAG of operations, the host processor should identify a sub-graph of operations, wherein each of the operations in the sub-graph maps to a corresponding execution unit of the processing module and wherein each connection between operations maps to a corresponding storage element of the processing module as described above.

The host processor is configured for determining s504 a size of a processing unit of said input data.

As described herein, memory constraints of a processing module which will execute the sub-graph may be important to consider when selecting the appropriate sub-graph-arrangement. The required buffer size for executing operations of a sub-graph largely depends on how big a processing unit of input data is.

Operations such as a convolution operation can be separated into blocks, each block representing a subset of the dimensions of the operation. Breaking the operation into blocks involves separating the operation space of the operation into multiple blocks which each individually represent a portion of the operation but collectively represent the operation space. This block generation involves separating the operation space into blocks representing a non-overlapping subset of the dimensions in the operation space which wholly cover the operation space dimensions (as further described above in the section “Operation space and operation-specific local space”). In an example where the operation is to be separated into a number of blocks, the operation space is broken down into blocks based upon a pre-determined block-size which defines for each dimension of the operation a fixed size.

This fixed size block is referred to herein as a block quantum or processing unit. The host processor may determine a suitable block size by evaluating a number of factors:

A block quantum for a sub-graph is better if it:
a) Reduces memory traffic. A convolution or matrix-matrix multiply operation requires its inputs multiple times, and such re-fetch is reduced with larger block quanta along the right dimensions.
b) Is aligned to units of data layout such that it results in full cache line reads and writes for input and output tensors.
c) Avoid causing too small block buffers for memory reads. For example, to cover the DRAM latency with two block buffers, a certain amount of transactions may be needed to satisfy this.
d) Avoid causing too large block buffers for memory reads/writes. Block reads that can be satisfied with one set of outstanding transfers may be preferred, otherwise more than a double buffer may be needed to execute an operation/graph of operations properly.

As can be understood, determining a suitable size of the block quantum may improve efficiency. However, if the size is too large for the memory of a processing module to handle, external read and writes may be needed which may increase latency. External memory usage should be used sparingly. As such, it is advantageous if the sub-graph requires a buffer allocation for the determined block quantum that the processing module can provide.

Consequently, the host processor may be configured for determining S506, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data. The simulation advantageously corresponds to a worst-case scenario of memory requirements for execution of the candidate sub-graph, to provide margins. For example, clipping may be disabled. Advantageously, if the simulation shows that memory constraints (of the processing module) is not adhered to at a certain point in the candidate sub-graph, the simulation may be aborted to save time and cycles, and the candidate sub-graph may be rejected. On the other hand, if the simulation shows that a buffer size of each storage elements of the processing module meets a corresponding estimated required buffer size according to the simulation, the sub-graph may be selected for execution.

A candidate sub-graph may be determined S506 according to the following heuristics. However, it should be noted that other ways of partitioning a DAG of operations into sub-graphs are equally possible.

In one embodiment, the partitioning is started by determining a mandatory chain, or initial candidate sub-graph. This may be achieved by determine storage bandwidth requirements of the operations of the DAG such that limitations of the pipes of the hardware implementation of the processing module may be adhered to. The initial candidate sub-graph may comprise one or more operations, and in some embodiments, the initial candidate sub-graph may be determined using other strategies.

In one embodiment, for each initial candidate sub-graph, it is attempted to grow the initial candidate sub-graph downwards (add in successor chains) as long as adding in the successor chain would not result in recompute, and the chain has a valid buffer allocation for a “typical” block quantum as described above. Recompute in this context refers to that adding the first operation to the initial candidate sub-graph results in a recompute of any data item of the input data to the selected operation at a parent node to the selected operation in the initial candidate sub-graph. Put differently, recompute refers to the effect where an operation in a chain needs an element from an input data more than once. If the input simply comes from memory, the only effect is that the element must be fetched from memory more than once (e.g. using the Input Reader DMA unit), but if the input is produced by another operation (the parent node), this means the operation must be computed more than once for an element. The following is an example of a chain of operation resulting in a re-compute.

Consider the case of a 3×3 convolution. A 3×3 convolution may need a window of 3×3 input elements to perform its operation. This means that if the execution unit work on an output block of 8×8 elements, two extra elements of the input may be needed in each direction, and the corresponding input block is 10×10. These input blocks are fetched with a stride of 8, so the last two elements of each block are actually used twice.

If we have a standalone convolution with the input coming from memory, the chain will look like this: Input Read=>Conv2D. For each 8×8 output, we fetch a 10×10 block with stride 8×8. This means that each element is fetched (10×10)/(8×8)=1.56 times.

However, if the chain is extended with a transpose in front of the Conv2D, the chain looks like this: Input Read=>Transpose (x,y)=>Conv2D. Now the transpose for each element needs to be performed (10×10)/(8×8)=1.56 times, which means recompute. To further clarify, the sequence of a Transpose and a Conv2D may be scheduled as one or two chains. The first case comprises scheduling the sequence as Input Read=>Transpose=>Output Write and then Input Read=>Conv2D. This would result in 3.56× of memory traffic and 1× of transpose computation. The second case is one chain comprising Input Read=>Transpose=>Conv2D. As described above, the transpose for each element needs to be performed (10×10)/(8×8)=1.56 times, which means recompute. The memory traffic is reduced to 1.56×. The first case makes sense if compute should be reduced, whereas the second case makes sense if memory traffic should be reduced.

In one embodiment, for each initial candidate sub-graph (which may have been extended downwards as described above), it is attempted to grow the initial candidate-sub-graph upwards (add predecessor chains). This may be done unless it is determined that too many of the operations in the thus formed sub-graph need to be executed by a same execution unit. In examples, a single execution unit, such as a convolution engine, may be configured at different instances in time to execute different instances of the convolution operation (e.g., first and second sections). However, this is only possible up to a certain number of operations requiring the same execution engine, wherein such threshold is based on at least one of the execution unit at hand, the input data, the operations of the DAG, the size of the processing unit, and memory constraints of the processing module. For example, a maximum number of sections may be supported on the same execution unit, and the maximum number of sections may differ between execution units.

From the candidate sub-graphs determined in step S506, a first sub-graph may thus be selected S508, wherein a buffer size of each storage elements of the processing module meets a corresponding estimated required buffer size according to the simulation of the execution of the operations of the first sub-graph.

In some embodiments, an operation space for the selected sub-graph may be determined S510 as described above, for example by using the operation-specific local space having a highest dimensionality.

The method 500 further comprises issuing S512 first task data describing a task to be executed in the form of a plurality of operations of the first sub-graph to the command processing unit. The first task data may be included as a command in a command stream, for example by being compiled into machine code.

In some embodiments, it is determined S514 whether task data have been issued for the complete DAG. This means that sub-graphs from the candidate sub-graphs have been selected S508 such that all selected sub-graphs connected together forms the DAG. If the entire DAG have been sent away for execution, the method may end S518. Otherwise, the method 500 may iterate S516 back to selection S508 of yet another sub-graph as described above.

It should be noted that the above method may be adapted mutatis mutandis for a system comprising a plurality of offload processors, as described herein.

### Miscellaneous

In summary, the present disclosure relates to a system, method and non-transitory computer-readable storage medium for handling data. From a directed acyclic graph, DAG, of operations on input data a sub-graph of operations is identified, wherein each of the operations in the sub-graph maps to a corresponding execution unit of a processing module of the system and wherein each connection between operations maps to a corresponding storage element of the processing module. The sub-graph is identified such that a simulation of an execution of the operations of the candidate sub-graph according to a determined size of the processing unit of said input data shows that the processing module can execute the operations of the sub-graph such that memory constrains of the processing module are met and read-write operations to memory external to the processing module are avoided or reduced.

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A system for handling data, the system comprising a host processor and an offload processor, the offload processor comprising a command processing unit connected to a processing module, the processing module comprising a storage with a plurality of storage elements, and a plurality of execution units, the host processor configured to:
from a directed acyclic graph, DAG, of operations on input data, identify a sub-graph of operations, wherein each of the operations in the sub-graph maps to a corresponding execution unit of the processing module and wherein each connection between operations maps to a corresponding storage element of the processing module, wherein the host processor is configured to identify the sub-graph of operations by:
determining a size of a processing unit of said input data;
determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and
selecting a first sub-graph from the plurality of candidate sub-graphs, wherein a buffer size of each storage elements of the processing module meets a corresponding estimated required buffer size according to the simulation of the execution of the operations of the first sub-graph,
issue first task data describing a task to be executed in the form of a plurality of operations of the first sub-graph to the command processing unit.

2. The system of claim 1, wherein the host processor is further configured to:
determine an operation space for the first sub-graph, the operation space representing dimensions of a multi-dimensional arrangement of the operations of the first sub-graph to be executed,
wherein the first task data further define the operation space determined for the first sub-graph.

3. The system of claim 2, wherein the operation space for the first sub-graph is determined by:
for each operation of the first sub-graph, determining an operation-specific local space, and
determining the operation space by selecting the operation-specific local space having a highest dimensionality.

4. The system of claim 1, wherein the host processor is, when determining a plurality of candidate sub-graphs from the DAG, configured to:
select one or more operations forming an initial candidate sub-graph in the DAG,
select a first operation in the DAG connected to the initial candidate sub-graph in a forward traversal direction,
analyse whether adding the first operation to the initial candidate sub-graph results in a recompute of any data item of the input data to the selected operation at a parent node to the selected operation in the initial candidate sub-graph,
upon adding the first operation to the initial candidate sub-graph not resulting in a recompute, form a candidate sub-graph by adding the first operation to the initial candidate sub-graph;
optionally, wherein the host processor is, when selecting one or more operations forming an initial candidate sub-graph in the DAG, configured to: determine storage bandwidth requirements of the operations of the DAG.

5. The system of claim 1, the host processor is, when determining, from the DAG, a plurality of candidate sub-graphs, configured to:
select one or more operations forming an initial candidate sub-graph in the DAG,
select a second operation in the DAG connected to the initial candidate sub-graph in a backwards traversal direction,
upon determining that less than a threshold number of the execution units of the one or more operations of the initial candidate sub-graph equals the execution unit of the second operation, form a candidate sub-graph by adding the second operation to the initial sub-graph.

6. A system of claim 1, comprising a second offload processor comprising a second command processing unit connected to a second processing module, the second processing module comprising a storage with a plurality of storage elements, and a plurality of execution units, wherein the host processor is configured to identify a second sub-graph of operations, wherein each of the operations in the second sub-graph maps to a corresponding execution unit of the second processing module and wherein each connection between operations maps to a corresponding storage element of the second processing module, wherein the host processor is configured to identify the second sub-graph of operations by:
selecting a second sub-graph from the plurality of candidate sub-graphs, wherein a buffer size of each storage elements of the second processing module meets a corresponding estimated required buffer size according to the simulation of the execution of the operations of the second sub-graph, and
issuing second task data describing a second task to be executed in the form of a plurality of operations of the second sub-graph to the second processing module.

7. A system of claim 1, wherein the host processor is configured to:
iteratively performing the steps of selecting sub-graphs from the candidate sub-graphs until all selected sub-graphs connected together forms the DAG.

8. A system of claim 1, wherein at least two connections between operations in the first sub-graph maps to a same corresponding storage element of the first processing module.

9. A system of claim 1, wherein the host processor is configured to:
compile the first task data into machine instructions.

10. A system of claim 1, wherein the host processor is, when estimating a required buffer size, configured to simulate a worst case for each non-linear operations of the operations of the candidate sub-graph.

11. A method for handling data by a host processor, the host processor being part of a system further comprising an offload processor, the offload processor comprising a command processing unit connected to a processing module, the processing module comprising a storage with a plurality of storage elements, and a plurality of execution units, the method comprising:
from a directed acyclic graph, DAG, of operations on input data, identifying a sub-graph of operations, wherein each of the operations in the sub-graph maps to a corresponding execution unit of the processing module and wherein each connection between operations maps to a corresponding storage element of the processing module, wherein identifying the sub-graph of operations comprises:
determining a size of a processing unit of said input data;
determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and
selecting a first sub-graph from the plurality of candidate sub-graphs, wherein a buffer size of each storage elements of the processing module meets a corresponding estimated required buffer size according to the simulation of the execution of the operations of the first sub-graph,
issuing first task data describing a task to be executed in the form of a plurality of operations of the first sub-graph to the command processing unit.

12. The method of claim 11, further comprising:
determining an operation space for the first sub-graph, the operation space representing dimensions of a multi-dimensional arrangement of the operations of the first sub-graph to be executed,
wherein the first task data further define the operation space determined for the first sub-graph, and optionally wherein determining an operation space for the first sub-graph comprises:
for each operation of the first sub-graph, determining an operation-specific local space, and
determining the operation space by selecting the operation-specific local space having a highest dimensionality.

13. The method of claim 11, wherein determining, from the DAG, a plurality of candidate sub-graphs comprises:
selecting one or more operations forming an initial candidate sub-graph in the DAG,
selecting a first operation in the DAG connected to the initial candidate sub-graph in a forward traversal direction,
analysing whether adding the first operation to the initial candidate sub-graph results in a recompute of any data item of the input data to the selected operation at a parent node to the selected operation in the initial candidate sub-graph;
upon adding the first operation to the initial candidate sub-graph not resulting in a recompute, forming a candidate sub-graph by adding the first operation to the initial candidate sub-graph.

14. The method of claim 11, wherein the step of determining, from the DAG, a plurality of candidate sub-graphs comprises:
selecting one or more operations forming an initial candidate sub-graph in the DAG,
selecting a second operation in the DAG connected to the initial candidate sub-graph in a backwards traversal direction,
upon determining that less than a threshold number of the execution units of the one or more operations of the initial candidate sub-graph equals the execution unit of the second operation, forming a candidate sub-graph by adding the second operation to the initial sub-graph.
optionally, wherein selecting one or more operations forming an initial candidate sub-graph in the DAG comprises determining storage bandwidth requirements of the operations of the DAG.

15. The method of claim 11, wherein the system comprises a second offload processor comprising a second command processing unit connected to a second processing module, the second processing module comprising a storage with a plurality of storage elements, and a plurality of execution units, the method further comprising:
identifying a second sub-graph of operations, wherein each of the operations in the second sub-graph maps to a corresponding execution unit of the second processing module and wherein each connection between operations maps to a corresponding storage element of the second processing module, wherein identifying the second sub-graph of operations comprises:
selecting a second sub-graph from the plurality of candidate sub-graphs, wherein a buffer size of each storage elements of the second processing module meets a corresponding estimated required buffer size according to the simulation of the execution of the operations of the second sub-graph, and
issuing second task data describing a second task to be executed in the form of a plurality of operations of the second sub-graph to the second processing module.

16. The method of claim 11, further comprising:
iteratively performing the steps of selecting sub-graphs from the candidate sub-graphs until all selected sub-graphs connected together forms the DAG.

17. The method of claim 11, wherein at least two connections between operations in the first sub-graph maps to a same corresponding storage element of the first processing module.

18. The method of claim 11, further comprising:
compiling the first task data into machine instructions.

19. The method of claim 11, wherein the step of estimating a required buffer size comprises:
simulating a worst case for each non-linear operations of the operations of the candidate sub-graph.

20. A non-transitory computer-readable storage medium comprising a set of computer-readable instructions stored thereon which, when executed by at least one host processor in a system further comprising an offload processor, the offload processor comprising a command processing unit connected to a processing module, the processing module comprising a storage with a plurality of storage elements, and a plurality of execution units, the instructions are arranged to cause the host processor to:
from a directed acyclic graph, DAG, of operations on input data, identifying a sub-graph of operations, wherein each of the operations in the sub-graph maps to a corresponding execution unit of the processing module and wherein each connection between operations maps to a corresponding storage element of the processing module, wherein identifying the sub-graph of operations comprises:
determining a size of a processing unit of said input data;
determining, from the DAG, a plurality of candidate sub-graphs, each comprising a subset of operations of the DAG, and for each candidate sub-graph, estimating a required buffer size of each storage element mapping to the connections between the operations of the candidate sub-graph by simulating an execution of the operations of the candidate sub-graph according to the determined size of the processing unit of said input data, and
selecting a first sub-graph from the plurality of candidate sub-graphs, wherein a buffer size of each storage elements of the processing module meets a corresponding estimated required buffer size according to the simulation of the execution of the operations of the first sub-graph,
issuing first task data describing a task to be executed in the form of a plurality of operations of the first sub-graph to the command processing unit.
